(19) United States
(12) Patent Application Publication
(10) Pub. No.: US 2007/0278406 A1
(43) Pub. Date: Dec. 6, 2007

(54) Night-Vision System For Motor Vehicles Having A Partial Optical Filter

(76) Inventor: Karsten Haug, Stuttgart (DE)

Correspondence Address: KENYON & KENYON LLP, ONE BROADWAY, NEW YORK, NY, 10004, US

(21) Appl. No.: 10/583,201

(22) PCT Filed: Nov. 22, 2004
(86) PCT No.: PCT/EP04/53035

§ 371 Date: May 17, 2007

(30) Foreign Application Priority Data
Jan. 10, 2004 (DE) 10 2004 001 556.2

(51) Int. Cl. G01J 5/00; G02B 5/22

(52) U.S. Cl. 250/338.1; 359/885

(57) ABSTRACT

A night-vision system for motor vehicles includes a camera having a radiation-sensitive image-sensor surface, which is configured for recording electromagnetic radiation from the infrared range, in particular. To improve distant-vision characteristics beyond the low-beam range, the system according to the present invention includes a filter element which is positioned in the optical path of the night-vision system in such a way that it causes an attenuation of the recorded radiation to predefined partial regions of the image sensor. This allows an attenuation of the radiation from the low-beam range, which would otherwise be too intense.

### FIELD OF THE INVENTION

The present invention relates to a night-vision system for motor vehicles, which includes a camera having an image sensor surface that is sensitive to radiation and which is configured to detect electromagnetic radiation from the near-infrared range.

### BACKGROUND INFORMATION

Systems for night-vision assistance are becoming more common in motor vehicles. Night-vision systems serve the purpose of improving the driver's vision at night, beyond the range of a dimmed headlight, through the use of cameras and displays or windshield projections. The oncoming traffic must not be blinded by glare as would be the case with a conventional high beam, which also includes light in the visible range.

Night-vision assistance is achieved by utilization and detection of wavelength ranges that are not visible to the human eye. These are made accessible to the driver via cameras, using displays or windshield projections (for instance, by head-up displays).

Conventional halogen headlights (high beam and low beam) include both spectral components in the visible range (VIS, 380 nm-780 nm, cf. DIN 5030 part 2) and also in the near-infrared (NIR IR-A, 780 nm-1400 nm). Current NIR high beam headlights use conventional halogen bulbs and block the visible range with the aid of optical filters. In the future, NIR high beam headlights based on lasers or LED's may become available as well. Video cameras on the basis of CCD or CMOS technology have a spectral sensitivity that ranges from approximately 380 nm to roughly 1100 nm. That is to say, only the range between 780 nm and 1100 nm of the NIR-IR-A range is utilized. It is denoted by NIR range in the following.

Various known night-vision systems utilize the non-visible near-infrared range (NIR range) having wavelengths of 780 to approximately 1100 nm. In these NIR-based, so-called active systems (in contrast to systems that are based on heat radiation of the far-infrared) the region illuminated by NIR high beam headlights of the motor vehicle is recorded as near-infrared image using a video camera, and is visualized to the driver by means of a display (conventional or head-up display) in order to provide night-vision assistance to the driver.

In pure NIR systems (without VIS range utilization), the image from the NIR region of 780 nm to approximately 1100 nm is merely recorded by the camera and made visible to the driver on a display or head-up display. Such a system is described in an article by Kunihiko Toyofuku et al.: “The Night View System using Near-Infrared Light” in SAE 2003-01-0018, p. 33-p. 38. There, a block filter in the optical path in front of the image sensor (imager) completely suppresses the recording of the visible range (VIS range), i.e., the wavelengths between 380 and 780 However, in doing so, possible improvements in the image quality of the image regions relevant for night-vision assistance are prevented by radiation from the visible (VIS) range, and safety-relevant information about preceding vehicles, such as LED-based brake lights, which is available only in the visible range, is withheld from the driver.

In addition, mixed NIR-VIS systems are known. Here, radiation both from the NIR and the VIS range is recorded and the image visualized on a display. The camera utilized for this purpose is sensitive in a wavelength range of approximately λ_low to λ_high, λ_low lying in the visible range between 380 nm and 780 nm, and λ_high lying between 780 nm and 1100 nm in the NIR range.

One particular problem in pure NIR systems and in the combined NIR-VIS systems is the uneven illumination of the region detected via the camera. For better vision at night, it is mainly the visualization of the visual field beyond the low beam range that is of interest. The low beam range (denoted as close range in the following) is already sufficiently illuminated by the low beam and thus of secondary importance, but it is displayed (at least partially) nevertheless so as to facilitate driver orientation when viewing the night vision image. The camera image for this range is brightly illuminated because the conventional low beam and the NIR high beam supplement each other. In addition, close regions are more highly illuminated as a matter of principle and imaged more brightly than more distant zones.

Part of the limited brightness dynamics of the camera and the displays is thus “given away” because of the bright close range, so that dark regions, beyond the close range, for example (denoted as far range in the following), are no longer able to be resolved as well.

Furthermore, the driver's attention becomes increasingly drawn to the bright close range, thereby making it more difficult to perceive critical details in the far range.

Dimming of areas that are brighter than desired, computer-implemented by software algorithms in the processing of the image (in pure display systems also known as image processing), requires complicated computer work and additional memory capacity, which increases the cost of the correspondingly equipped night-vision control device. In basic night-vision systems, which do not include an image-processing computer, such software-based postworking of the camera image is not possible.

Overmodulations of the imager due to limited brightness dynamics are also no longer able to be corrected by software-based postprocessing. In addition, a wavelength-dependent attenuation of the close range via software algorithms is not possible in gray-value cameras, and only with great effort in the case of color cameras.

### Summary

The present invention make it possible to attenuate the recorded radiation on predefined partial regions of the image-sensor surface of the camera of the night-vision system that would otherwise be regularly exposed to undesired high radiation intensity, such attenuation being implementable without the aid of image-processing software algorithms. Since according to the present invention the attenuation of the radiation in predefined partial regions is effected by an optical filter element appropriately disposed in the optical path of the night-vision system, the radiation is reduced in the desired image regions, for example the image of the excessively bright close range, in particular, even prior to being recorded. For the purpose of the present invention, the optical path denotes the path from the illuminated object to the imager. For the present invention, suitable positions of the filter element are positions in the section immediately in front of and/or within the camera.

This arrangement dispenses with costly software algorithms for image postworking in order to dim image areas that would normally have an undesired excessive brightness. In an uncomplicated manner, the driver's gaze is focused more on the image sections that are of interest for night vision assistance. Overmodulation of partial regions of the image-sensor surface is avoided, and the available brightness dynamics of the camera and display with respect to the image regions relevant for night-vision assistance are utilized in an optimal manner.

An advantageous example embodiment of the system according to the present invention includes a camera, which is sensitive in a wavelength range of 380 to 1100 nm. The radiation is recorded both from the VIS and NIR range, which improves the quality of the night-vision assistance (LED brake lights and tail-gate lights, for example, are visible as well).

Another advantageous example embodiment of the night-vision system according to the present invention is the filter-related attenuation of the radiation of at least the area of the image-sensor surface on which the close range is imaged from the driver's perspective.

This is the area immediately in front of the motor vehicle, which is already adequately viewable with the aid of the low beam from the driver's perspective. According to the present invention, the high brightness, caused particularly by a combination of low beam and NIR high beam, is thereby attenuated in this region of low interest in the context of night-vision assistance, which improves the night vision beyond the low-beam range. The driver's attention is not distracted by high brightness in the close range. Moreover, the dynamic range of the camera is utilized to better effect, so that dark image regions (especially in the far range) are able to be resolved more highly.

An advantageous further aspect of the present invention is a wavelength-dependent filter characteristic of the optical filter, which has a transmittance function that is individually adapted to the particular use of the system. For instance, the wavelength characteristic of the image sensor in the camera and/or the headlight may be taken into account by an inverse wavelength characteristic of the optical filter, thereby achieving a homogenous spectral sensitivity of the overall system across a large range of wavelengths.

Due to the selection of different spectral ranges of low beam and NIR high beam, the attenuation of the low beam is able to be simplified considerably. If the spectrums of NIR high beam and conventional low beam are selected such that they do not overlap (by blocking the NIR portion with the aid of an optical filter in the low-beam headlight, for instance), complete suppression of the low-beam light component in the NV image is possible (spectral separation).

Especially advantageous is a blocking of all spectral components beyond approximately 600 nm in the low-beam spectrum because this allows the night-vision camera to be configured in such a way (transmittance range of 600 to 1100 nm) that LED tail lights or brake lights having a wavelength of 625 nm, for instance, are still able to be detected despite suppression of the low beam. When configuring the wavelength-dependent filter characteristic, the spectral reflection behavior of the street (from asphalt, for example) may be taken into account as well.

The exchangeability of the optical filter constitutes an additional improvement. It allows a simple adaptation to different vehicle types or vehicle variants. Retrofitted systems may thus be adapted to different types of vehicles in a simple manner as well.

Especially suitable for effective attenuation of radiation from a specific object range, such as the close range, is the positioning of the filter immediately in front of the image-sensor surface. An optical filter in the form of a coating on the image-sensor surface is an advantageous variant in this context because it requires no affixation device for the filter. As an alternative, the filter may be applied as coating on a glass cover for the image sensor (glass lid), which protects the actual image sensor and its bond wires from damage. Alternatively, the lid itself may be embodied as optical filter. An integration of the filter into the lens may be advantageous as well. In particular, the coating of the last lens facing the imager suggests itself in this context.

### BRIEF DESCRIPTION OF THE DRAWINGS

FIG. 1 is a block diagram of an example embodiment of the night-vision system for motor vehicles according to the present invention.

FIG. 2 is a schematic illustration of a cross section of a camera having a filter element positioned in the optical path of a night-vision system according to the present invention to attenuate radiation recorded from the close range.

FIG. 3 is a graph to illustrate a wavelength-dependent transmittance characteristic of an example of a filter element utilizable according to the present invention in the optical path of a night-vision system.

FIG. 4 is a schematic illustration of an example embodiment of an image sensor surface having a coating that acts as filter according to the present invention and which is configured for use in a night-vision system for motor vehicles.

FIG. 5 is a depiction of the local intensity distribution of the low-beam headlight to illustrate an inverse local characteristic of an example embodiment of an optical filter for attenuating the close range, configured for use in a night-vision system for a motor vehicle.

### DETAILED DESCRIPTION

In the figures, identical or functionally equivalent components are denoted by matching reference numerals.

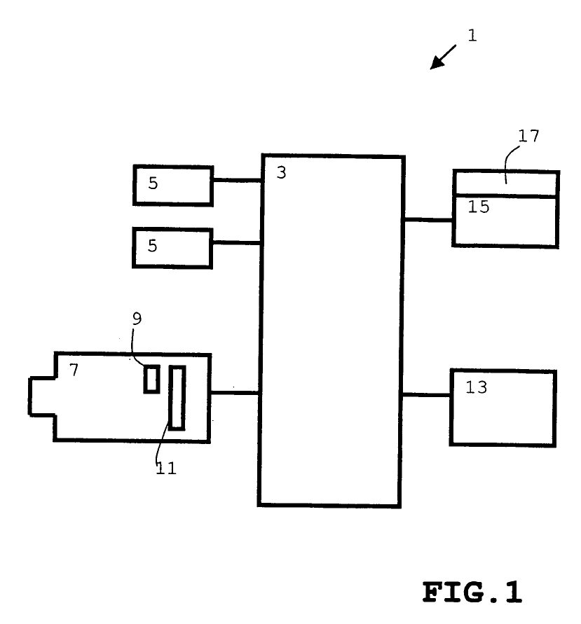

FIG. 1 shows a block diagram of an example embodiment of night-vision system 1 for motor vehicles according to the present invention. Night-vision system 1 includes a control unit 3, which is connected to the additional components of the system, controls the additional components and processes their signals and data.

Upon activation of the night-vision system by an operating unit 13, control unit 3 turns on NIR high-beam headlights 5. These headlights 5 illuminate a spatial range in the NIR wavelength range (780 to approximately 1100 nm) in front of the vehicle that is similar to that of conventional high beam headlights. The illumination range amounts to approximately 250 meters.

A camera 7, which is sensitive also to the NIR range and includes a CCD or CMOS image sensor (with linear or non-linear intensity characteristic in each case) and has a depth of focus from approximately 2 m to infinite, records, among others, the NIR radiation reflected by objects located in the NIR high-beam range. According to the present invention, camera 7 is equipped with an optical filter element 9, which is positioned in the optical path of night-vision system 1 and attenuates the radiation on a predefined partial region of image-sensor surface 11 in camera 7. The image-sensor surface is a CCD or CMOS chip, for example.

The image data recorded by camera 7 are transmitted to an imaging unit 15 by control unit 3. In imaging unit 15, the image of the camera is visualized on a display 17 for the driver. Display 17 is a so-called head-up display, for instance, by which the visualized image of the camera is reflected to a lower portion of the windshield in a manner that allows it to be clearly visible to the driver.

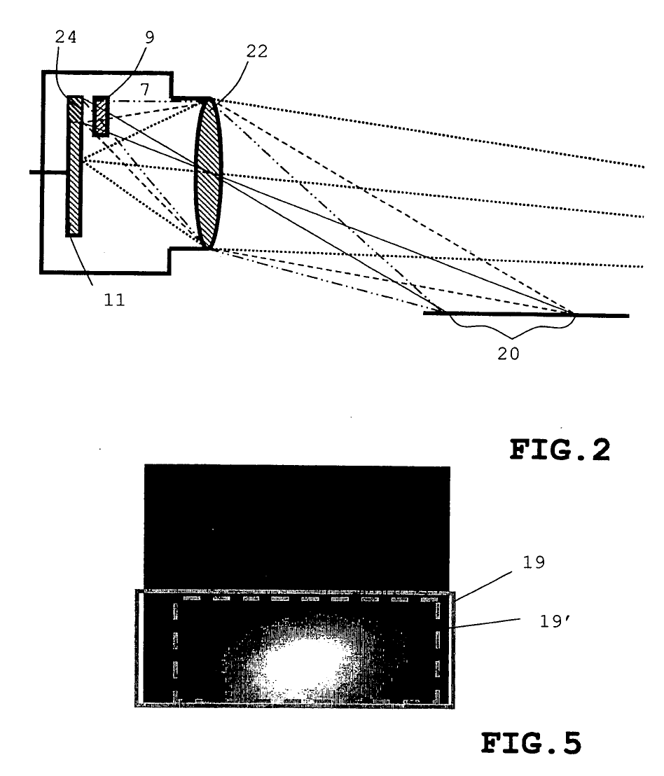

FIG. 2 shows a schematic sketch of a cross section of a camera 7 including a filter element 9 positioned in the optical path of a night-vision system according to the present invention so as to attenuate recorded radiation from close range 20. In the example embodiment shown in FIG. 2, such a filter element 9 is located immediately in front of the partial area of the image sensor on which the close range is imaged. The dashed lines represent the marginal rays of the beam of rays that radiate from the front and the back end of close range 20. The position of the filter element is selected such that all rays impinging on the image sensor surface from the close range pass through filter element 9. The solid lines represent the main point ray of the front or rear edge point of the close range. The dotted lines image a specific, randomly selected point from the far range which, as can be gathered from the drawing, is not attenuated by filter element 9.

It is advantageous to have filter element 9 as close as possible to image-sensor surface 11 in order to obtain the sharpest possible boundary between the close range image and the far range image with the smallest possible overlap, so that the fewest number of rays of image points from the far range is projected in a filtered manner, and the highest number of rays from close range 20 is filtered by filter 9.

The radiation from close range 20 recorded by camera 7 is projected onto an upper region of image-sensor surface 11, the so-called close range image region 24, via camera lens 22, which is shown as a lens overall. According to the present invention, filter element 9 is positioned directly in front of this close range image region 24.

Filter element 9 may be made of the material/the layers of a conventional interference filter or adsorption filter. This filter 9 attenuates the radiation from close range 20 according to its wavelength characteristic. The unfiltered radiation coming from the far range impinges upon the remaining portion of image sensor surface 11. For instance, a filter whose attenuation of the radiation has the inverse, locus-dependent characteristic of the imaging of the motor vehicle's low beam light is mounted in front of image sensor surface 11. However, other filter elements that cover a range going beyond the pure close range are conceivable as well. They have a locus-dependent filter characteristic, for instance, which orients itself on the overall intensity of the radiation recorded by camera 7 and thus not only corrects halation of the close range, but additionally also compensates for inhomogeneities in the far range by an inverse characteristic. A homogenous intensity of the entire visual range of the camera is able to be achieved in this way, so that vignetting, for example, is compensated. Filter 9, i.e., the filter coating, may then influence the entire imager surface or else only portions thereof.

Filter 9 may also have a wavelength-dependent transmittance characteristic. Furthermore, a combination of locus-dependent and wavelength-dependent characteristic is possible.

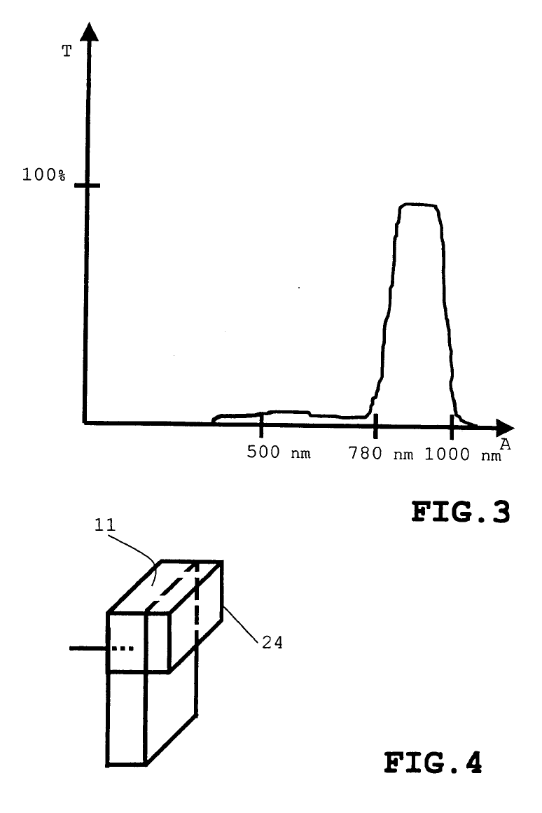

FIG. 3 illustrates, using a graph, an example of such a wavelength-dependent transmittance or transmittance characteristic of the filter.

Transmission rate T is a function over wavelength A. The attenuation for the visible range (380-780 nm) is very high at approximately 90%. In contrast, the suppression of radiation in the NIR range (780-1100 nm) amounts only to 4%. A combination of the locus-dependent characteristic with a wavelength-dependent transmittance characteristic is advantageous also for achieving a likewise high attenuation of the NIR radiation from the close range and an equally satisfactory transmittance of VIS and NIR radiation for the remaining image-sensor surface area.

FIG. 4 illustrates an example embodiment of an image-sensor surface 11, which is coated with an optical filter according to the present invention and configured for use in a night-vision system for motor vehicles. Image-sensor surface 11 has a coating that attenuates the radiation impinging thereon only for a partial region 24 of the image-sensor surface, in a locus-dependent manner. Coating 24 is made of a suitable material, as mentioned earlier. In addition to an always present wavelength-dependent characteristic, the filter effect may also have a locus-dependent characteristic, which is achieved by applying various coatings at different locations, for example.

With regard to the local filter characteristic, FIG. 5 shows the local intensity distribution of the low-beam light from the camera's perspective. Boxes 19 and 19″ drawn in gray mark the approximate close range and thus the position and size of optical filter 9 (to be affixed inversely). It can be seen clearly that the filter need not necessarily take up the entire width of the image sensor.

Since filter 9 (not shown in FIG. 5) should exhibit an inverse characteristic of the intensity in order to generate an image having the most uniform brightness for the driver, the following applies:

The filter is configured not to provide attenuation for dark regions, and filter 9 is to provide strong attenuation for bright areas. The brightness stages lying in-between should be imaged continuously, if possible, in an inverse manner as well.

The locally varying attenuation and the stepless variation, if possible, of the transmittance capacity of filter 9 is able to be realized in different ways.

For one, it may be achieved by a locally varying application of a different number of attenuation layers having the same transmissivity.

One attenuation layer has a transmissivity of 95%, for example. If five layers, for instance, are then applied on top of one another, one obtains an overall transmittance of 95% to the power of 5=77%. The different number of layers at different locations may be realized by masks or multiple coatings, for example.

For another, it may be achieved by a locally varying application of different layers having different transmissivity. In this manner, layers having transmissivities of 95%, 90%, 85% . . . , for example, are applied one after another using a plurality of masks that do not overlap. The two methods may also be combined.

Although the present invention was described above in terms of exemplary embodiments, it is not limited to these embodiments, but rather may be modified in numerous ways.

For instance, the optical filter may already be affixed in the optical path of the night-vision system in front of the camera. A partially filtering coating of the windshield, for instance, is conceivable.

1-14. (canceled)

15. A driver assistance night-vision system for a motor vehicle, comprising:
a camera having an image sensor and a filter element, wherein the image sensor is configured for recording electromagnetic radiation from the visible range and the infrared range of the spectrum, and wherein the filter element is positioned in an optical path of the night-vision system in such a way that the filter element causes an attenuation of recorded electromagnetic radiation from predefined partial areas of an image scene, and wherein the predefined partial areas of the image scene are imaged onto corresponding predefined partial areas of the image sensor.

16. The night-vision system as recited in claim 15, wherein the camera is sensitive in a wavelength range of 400 to 1100 nm.

17. The night-vision system as recited in claim 16, wherein the attenuation of the recorded electromagnetic radiation includes attenuation of electromagnetic radiation corresponding to a portion of the image scene in a close range from the driver's perspective.

18. The night-vision system as recited in claim 17, wherein the filter element has a wavelength-dependent filter characteristic, and wherein a transmittance function of the wavelength-dependent filter characteristic is adapted based on selected application criteria for the night-vision system.

19. The night-vision system as recited in claim 17, wherein the filter element has a locus-dependent filter characteristic, and wherein a transmittance function of the wavelength-dependent filter characteristic is adapted based on selected application criteria for the night-vision system.

20. The night-vision system as recited in claim 19, wherein the locus-dependent filter characteristic is set in accordance with an inverse, locus-dependent sensitivity of an overall optical system of the night-vision system, so as to compensate for lack of homogeneity of radiation intensity from a far range.

21. The night-vision system as recited in claim 17, wherein the filter element is affixed in an exchangeable manner.

22. The night-vision system as recited in claim 17, wherein the filter element is positioned directly in front of the image sensor.

23. The night-vision system as recited in claim 17, wherein the filter element is configured as a coating provided on the image sensor.

24. The night-vision system as recited in claim 17, wherein the filter element is configured as an integrated part of a protective glass for the image sensor.

25. The night-vision system as recited in claim 17, further comprising:
a control unit operatively coupled to the camera and a high-beam headlight and a low-beam headlight of the motor vehicle, wherein the high-beam headlight projects a light having a spectral range that substantially does not overlap with a spectral range of a light projected by the low-beam headlight.

26. A camera for a night-vision system for a motor vehicle, comprising:
a radiation-sensitive image-sensor surface configured for recording electromagnetic radiation in the infrared range;
a filter element positioned in an optical path of the night-vision system so as cause an attenuation of electromagnetic radiation recorded at predefined partial regions of the image-sensor surface.

27. A filter element for a night-vision system for motor vehicles, the night-vision system including a camera having a radiation-sensitive image-sensor surface configured for recording electromagnetic radiation in the infrared range, the filter element comprising:
a filter configured to be positioned in an optical path of the night-vision system so as to cause an attenuation of electromagnetic radiation recorded at predefined partial regions of the image-sensor surface.

28. An image-sensor for a camera in a night-vision system for a motor vehicle, comprising:
an image-sensor surface configured to record electromagnetic radiation from the infrared range, wherein the image-sensor surface includes a coating that causes an attenuation of electromagnetic radiation recorded on predefined partial areas of the image-sensor surface.
